(19) United States
(12) Patent Application Publication
(10) Pub. No.: US 2014/0006373 A1
(43) Pub. Date: Jan. 2, 2014

(54) AUTOMATED SUBJECT ANNOTATOR CREATION USING SUBJECT EXPANSION, ONTOLOGICAL MINING, AND NATURAL LANGUAGE PROCESSING TECHNIQUES

(71) Applicants: Philip E. Parker, York, SC (US); Patrick W. Fink, Charlotte, NC (US)

(72) Inventors: Philip E. Parker, York, SC (US); Patrick W. Fink, Charlotte, NC (US)

(73) Assignee: INTERNATIONAL BUSINESS MACHINES CORPORATION, Armonk, NY (US)

(21) Appl. No.: 13/538,440

(22) Filed: Jun. 29, 2012

(51) Int. Cl. G06F 17/30

(52) U.S. Cl. 707/709; 707/769; 707/E17.005; 707/E17.014; 707/E17.108

(57) ABSTRACT

A method, system and computer program product for creating a subject annotator. A user input query is accepted and specifies a target subject to be annotated. Based on the query, a search for similar words to the target subject is conducted and creates a set of related terms. The set of related terms are used to search for and identify further related terms. Both the related terms and further related terms are added to a master word list. The master word list is used to annotate the target subject.

### BACKGROUND OF THE INVENTION

1. Field of the Invention

The present invention relates generally to natural language processing, and in particular, to a method, apparatus, and article of manufacture for automatically (i.e., without additional user input) creating a subject annotator using subject expansion, ontological mining, and natural language processing techniques.

More specifically, in natural language processing, annotations are additional information about words and phrases within a document, denoting meaning, categorizations, structure, grammar, etc. Embodiments of the invention take a hierarchical knowledge base and extract word lists for the user-selected topic to create an annotator.

2. Description of the Related Art

Natural language presents an incredible challenge for text analytics. Ideas and concepts have many representations in language: some words represent fairly precise synonyms; others exhibit nuance in meaning or connotation that create shading or degrees of severity. For fields that have been evolving for long periods of time without an effort at standardization of terminology, vast vocabularies can develop.

A pertinent example of this today is the medical field. Medicine has been practiced for ages. New words are added and old are forgotten or morphed into new ones. Relatively recent attempts have been made at standardization, resulting in terminology sets for the field. For example, the SNOMED CT dataset provides a terminology set as well as a categorization of all terms. Every concept within the dataset appears in a hierarchy. For example, Concept->body part->organ->heart could be an example within the dataset.

Adding further complexity in our example, several specialties exist in the medical field. There are heart specialists, brain specialists, other organ specialties, as well as additional distinctions, such as age.

Using text analytics to aid the medical field and gather insights into their records requires that algorithms be able to locate concepts instead of individual words. For example, myocardial infarction is also known colloquially as a heart attack. Both words could appear in a medical document depending on the author's word choices and audience. Simple concept matching can be achieved via look-up dictionaries. However, it can be quite time consuming and cost prohibitive to create analysis engines by hand for each possible specialty and/or division of the field. In this regard, prior art techniques are manual in nature, and the time that it takes to create value from an engine is large due to the amount of effort required.

### SUMMARY OF THE INVENTION

Embodiments of the invention include a method, system and computer program product for creating a subject annotator. A user input query is accepted and specifies a target subject to be annotated. Based on the query, a search for similar words to the target subject is conducted and creates a set of related terms. The set of related terms are used to search for and identify further related terms. Both the related terms and further related terms are added to a master word list. The master word list is used to annotate the target subject.

Advantages of using embodiments of the invention over creating annotators by hand may include a massive reduction in effort.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system using a network to connect client computers to server computers in accordance with one or more embodiments of the invention;

FIG. 3 illustrates the logical flow for creating the subject annotator (e.g., a related terminology word list) in accordance with one or more embodiments of the invention; and

FIG. 4 illustrates the structure for a sample text analysis engine in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Hardware Environment

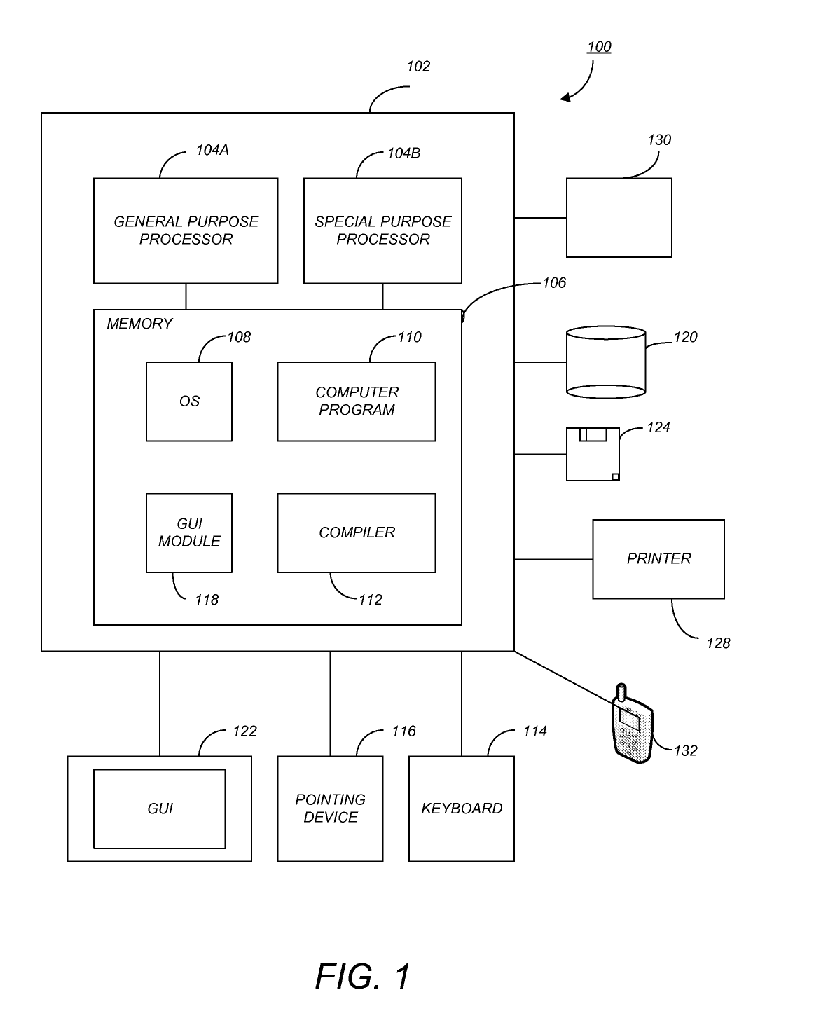

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may be coupled to, and/or integrated with, other devices, including input/output (I/O) devices such as a keyboard 114, a cursor control device 116 (e.g., a mouse, a pointing device, pen and tablet, touch screen, multi-touch device, etc.) and a printer 128. In one or more embodiments, computer 102 may be coupled to, or may comprise, a portable or media viewing/listening device 132 (e.g., an MP3 player, portable digital video player, cellular device, personal digital assistant, etc.). In yet another embodiment, the computer 102 may comprise a multi-touch device, mobile phone, gaming system, internet enabled television, television set top box, or other internet enabled device executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108, to provide output and results.

Output/results may be presented on the display 122 or provided to another device for presentation or further processing or action. In one embodiment, the display 122 comprises a liquid crystal display (LCD) having a plurality of separately addressable liquid crystals. Alternatively, the display 122 may comprise a light emitting diode (LED) display having clusters of red, green and blue diodes driven together to form full-color pixels. Each liquid crystal or pixel of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118. Although the GUI module 118 is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of multi-touch devices include mobile devices, tablet computers, portable/handheld game/music/video player/console devices, touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program 110 instructions. In one embodiment, the special purpose processor 104B is an application specific integrated circuit (ASIC).

The computer 102 may also implement a compiler 112 that allows an application or computer program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java, Perl, Basic, etc. After completion, the application or computer program 110 accesses and manipulates data accepted from I/O devices and stored in the memory 106 of the computer 102 using the relationships and logic that were generated using the compiler 112. (Java and all Java-based trademarks and logos are trademarks or registered trademarks of Oracle and/or its affiliates.)

The computer 102 also optionally comprises an external communication device such as a modem, satellite link, Ethernet card, or other device for accepting input from, and providing output to, other computers 102.

In one embodiment, instructions implementing the operating system 108, the computer program 110, and the compiler 112 are embodied in a data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program 110 instructions which, when accessed, read and executed by the computer 102, cause the computer 102 to perform the steps necessary to use the present invention or to load the program of instructions into a memory 106, thus creating a special purpose data structure causing the computer 102 to operate as a specially programmed computer executing the method steps described herein. Computer program 110 and/or operating instructions may also be tangibly embodied in memory 106 and/or data communications devices 130, thereby making a computer program product or article of manufacture according to the invention.

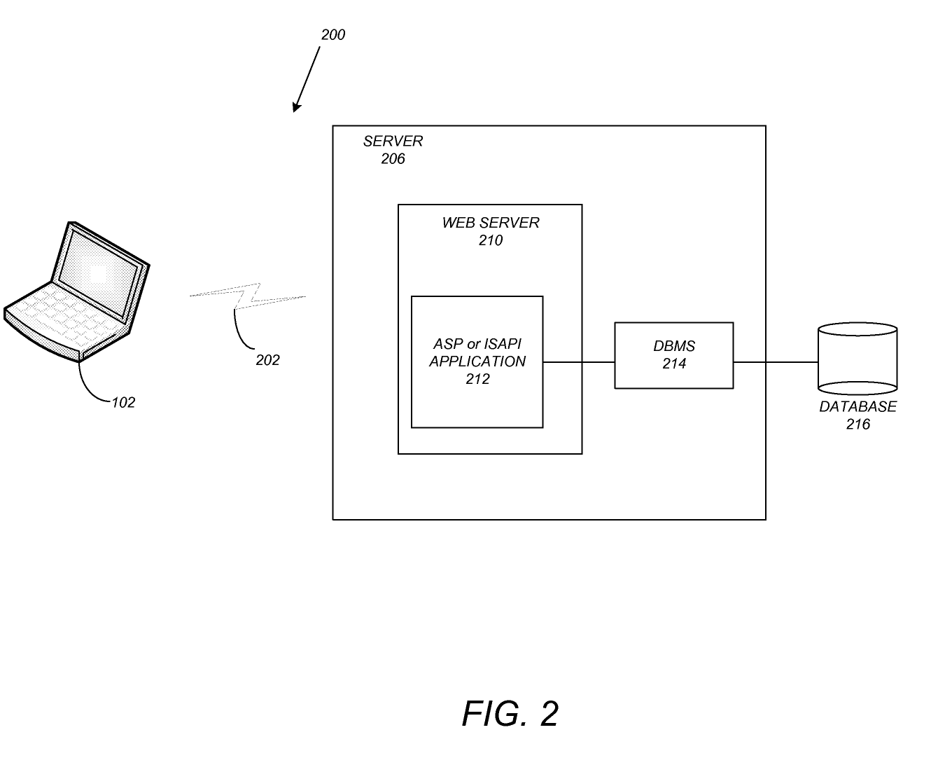

FIG. 2 schematically illustrates a typical distributed computer system 200 using a network 202 to connect client computers 102 to server computers 206. A typical combination of resources may include a network 202 comprising the Internet, LANs (local area networks), WANs (wide area networks), SNA (systems network architecture) networks, or the like, clients 102 that are personal computers or workstations, and servers 206 that are personal computers, workstations, minicomputers, or mainframes (as set forth in FIG. 1). However, it may be noted that different networks such as a cellular network (e.g., GSM [global system for mobile communications] or otherwise), a satellite based network, or any other type of network may be used to connect clients 102 and servers 206 in accordance with embodiments of the invention.

A network 202 such as the Internet connects clients 102 to server computers 206. Network 202 may utilize ethernet, coaxial cable, wireless communications, radio frequency (RF), etc. to connect and provide the communication between clients 102 and servers 206. Clients 102 may execute a client application or commercially available or open source web browser and communicate with server computers 206 executing web servers 210. Further, the software executing on clients 102 may be downloaded from server computer 206 to client computers 102 and installed as a plug-in or control of a web browser, as is well known in the art. Accordingly, clients 102 may utilize ACTIVEX components/component object model (COM) or distributed COM (DCOM) components to provide a user interface on a display of client 102. The web server 210 is typically a program such as the Internet Information Server from Microsoft. (Microsoft is a trademark of Microsoft Corporation in the United States, other countries, or both.)

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of, or connected directly to, client 102 instead of communicating/obtaining the information from database 216 across network 202. When a developer encapsulates the business functionality into objects, the system may be referred to as a component object model (COM) system. Accordingly, the scripts executing on web server 210 (and/or application 212) invoke COM objects that implement the business logic. Further, server 206 may utilize Microsoft's Transaction Server (MTS) to access required data stored in database 216 via an interface such as ADO (Active Data Objects), OLE DB (Object Linking and Embedding DataBase), or ODBC (Open DataBase Connectivity).

Although the terms “user computer”, “client computer”, and/or “server computer” are referred to herein, it is understood that such computers 102 and 206 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 102 and 206.

### Software Embodiment Overview

Embodiments of the invention are implemented as a software application on a client 102 or server computer 206. Further, as described above, the client 102 or server computer 206 may comprise a thin client device or a portable device that has a multi-touch-based display.

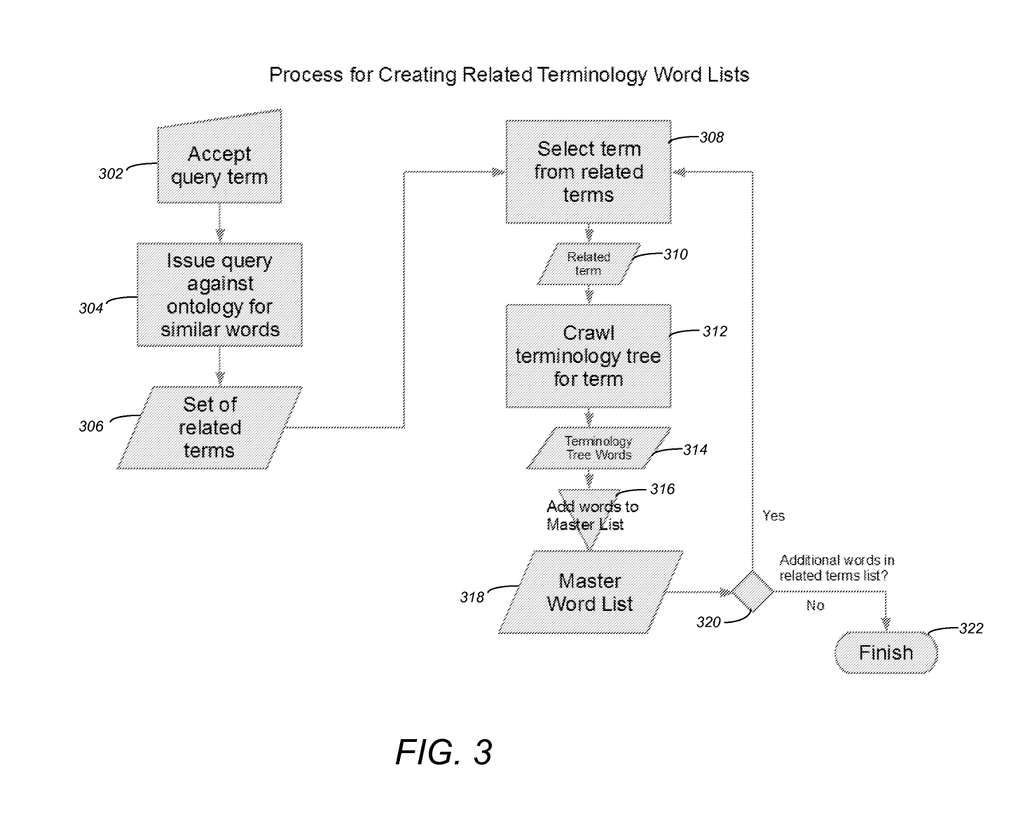

As described above, embodiments of the invention utilize terminology standardization and categorization to create annotators for a field of study. FIG. 3 illustrates the logical flow for creating the subject annotator (e.g., a related terminology word list) in accordance with one or more embodiments of the invention.

At step 302, a query term (user input query) that specifies a target subject to be annotated is accepted.

At step 304, based on the query, a search is conducted/issued (e.g., against an ontology or on a terminology source tree) for similar words to the target subject to create a set of related terms 306.

At steps 308-320, the set of related terms are searched to identify further related terms that are added to a master word list. Such searching is performed automatically (e.g., without additional user input).

In FIG. 3, steps 308-320 describe an exemplary specific sequence of steps that can be used to create a master word list. In the example illustrated, at step 308, a term 310 is selected from the set of related terms 306. Using the related term 310, a terminology tree is repetitively crawled at step 312 to determine terminology tree words 314. The terminology tree words 314 are added to the master word list at step 316. Thereafter, a determination is made at step 320 if there are more terms in the set/list of related terms 306. If more terms exist, the process returns to step 308. If no more terms are in the set of related terms 306, the process is complete at step 322 at which point the master word list 318 is used to annotate the target subject. In view of the above, the search using the set of related terms is performed by repetitively crawling the set of related terms 306 and the further related terms 314 (found in the terminology tree) and adding all of the terms 310 and 314 to the master word list 318.

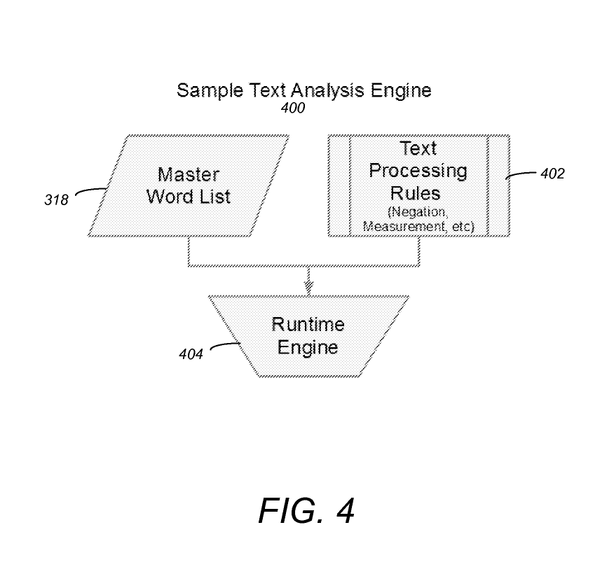

Once the master word list 318 is complete, it can be incorporated into a text analysis engine to begin analyzing documents from the targeted field (i.e., at step 322). FIG. 4 illustrates the structure for a sample text analysis engine in accordance with one or more embodiments of the invention. As illustrated, the master word list 318 may be incorporated into the analysis engine 400 that is configured to report all instances of the terms from the master word list 318 that are identified in a document. Such an analysis engine 400 may apply text processing rules 402 to the master word list 318 when analyzing the document. Such text processing rules 402 may define a spatial rule that determines if a term is located within a defined spatial proximity from another term in the document. Alternatively (or in addition), the text processing rules 402 may provide a negation rule. Both the spatial rule and negation rule are two examples of the types of text processing rules that may be utilized in embodiments of the invention. Thus, as illustrated, the runtime engine 404 applies the text processing rules 402 to the master word list 318 to perform the text analysis in a given document.

### Exemplary Implementation

One exemplary implementation of an embodiment of the invention could be within a UIMA (unstructured information management architecture) pipeline, which is particularly suited to this task. UIMA pipelines serve to link together text analysis engines in a serial fashion, whereby the results of each text analysis engine are available to the subsequent text analysis engines. In this implementation, embodiments of the invention would take the form of a UIMA-compliant annotator. Furthermore, IBM® LanguageWare® Resource Workbench could be used to accelerate development of additional processing rules after the creation of the specialized terminology set. (IBM and LanguageWare are trademarks of International Business Machines Corporation, registered in many jurisdictions worldwide.)

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention. In summary, embodiments of the invention provide the ability to create a subject annotator (as part of a specialized text analysis engine for fields of study that have existing ontology and terminology sets). Stated in other terms, embodiments of the invention utilize an ontology (i.e., a set of concepts and relationships among the concepts) of information to automatically create dictionaries within a knowledge domain, and uses the dictionaries to automatically analyze text/documents in the domain using an analysis engine. To create the dictionaries, the ontology is used to exhaustively search for items related to a given user-selected topic. All of the related topics are compiled into a word list/dictionary that is then used as an annotator for the user selected topic (i.e., within a natural language processing field).

In view of the above, embodiments of the invention provide for the automated creation of specialized text analysis engines for fields of study that have existing ontology and terminology sets. Such an automation of the analysis engine creation process greatly improves the time-to-value ratio.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1-8. (canceled)

9. An apparatus for creating a subject annotator in a computer system comprising:
(a) a computer having a memory; and
(b) an application executing on the computer, wherein the application is configured to:
(1) accept a user input query that specifies a target subject to be annotated;
(2) based on the query, searching for similar words to the target subject to create a set of related terms;
(3) searching, using the set of related terms, to identify further related terms, wherein the set of related terms and further related terms are added to a master word list; and
(4) utilizing the master word list to annotate the target subject.

10. The apparatus of claim 9, wherein the searching for similar words is performed on an ontology.

11. The apparatus of claim 9, wherein the searching for similar words is performed on a terminology source tree.

12. The apparatus of claim 9, wherein the searching using the set of related terms is performed by repetitively crawling the set of related terms and the further related terms in a terminology tree.

13. The apparatus of claim 9, wherein the utilizing comprises incorporating the master word list into an analysis engine that is configured to report all instances of the terms from the master word list that are identified in a document.

14. The apparatus of claim 13, wherein the analysis engine applies one or more text processing rules to the master word list when analyzing the document.

15. The apparatus of claim 14, wherein one of the one or more text processing rules comprises a spatial rule that determines if a term is located within a defined spatial proximity from another term in the document.

16. The apparatus of claim 14, wherein one of the one or more text processing rules comprises a negation rule.

17. A computer program product including a computer readable storage medium encoded with computer program instructions, which when accessed by a computer, cause the computer to execute a method of creating a subject annotator, comprising:
(a) accepting, in the specially programmed computer, a user input query that specifies a target subject to be annotated;
(b) based on the query, searching, in the specially programmed computer, for similar words to the target subject to create a set of related terms;
(c) searching, in the specially programmed computer, using the set of related terms, to identify further related terms, wherein the set of related terms and further related terms are added to a master word list; and
(d) utilizing, in the specially programmed computer, the master word list to annotate the target subject.

18. The computer program product of claim 17, wherein the searching for similar words is performed on an ontology.

19. The program product of claim 17, wherein the searching for similar words is performed on a terminology source tree.

20. The program product of claim 17, wherein the searching using the set of related terms is performed by repetitively crawling the set of related terms and the further related terms in a terminology tree.

21. The computer program product of claim 17, wherein the utilizing comprises incorporating the master word list into an analysis engine that is configured to report all instances of the terms from the master word list that are identified in a document.

22. The computer program product of claim 21, wherein the analysis engine applies one or more text processing rules to the master word list when analyzing the document.

23. The computer program product of claim 22, wherein one of the one or more text processing rules comprises a spatial rule that determines if a term is located within a defined spatial proximity from another term in the document.

24. The computer program product of claim 22, wherein one of the one or more text processing rules comprises a negation rule.
